(19) United States
(12) Patent Application Publication
(10) Pub. No.: US 2023/0230496 A1
(43) Pub. Date: Jul. 20, 2023

(54) SMART PHONE USAGE MONITORING AND MANAGEMENT SYSTEM

(71) Applicant: BetterYou LLC, St Paul, MN (US)

(72) Inventors: Sean Higgins, Falcon Heights, MN (US); Tommy Khoo, St. Paul, MN (US); Edwin Melendez, Saint Paul, MN (US)

(21) Appl. No.: 18/158,386

(22) Filed: Jan. 23, 2023

Related U.S. Application Data
(63) Continuation of application No. 16/520,636, filed on Jul. 24, 2019, now abandoned.

(51) Int. Cl. G09B 19/00; H04M 1/724; G06F 3/04847; G06F 3/0482; H04L 67/10

(52) U.S. Cl. CPC G09B 19/00; H04M 1/724; G06F 3/04847; G06F 3/0482; H04L 67/10; H04M 2250/22; H04M 2250/12; H04M 2250/10

(57) ABSTRACT

According to example embodiments, there is provided a handheld mobile computing device, for example a smartphone, includes a computing system, a motion detector, a global positioning system receiver, and a touch-screen display to display a user interface and detect user selections from the user interface. A usage goal-setting user interface includes a dashboard and a plurality of user-selectable menu options, the usage goal-setting user interface including display elements allowing a user to enter one or more parameters respecting the goals including physical activity usage goals, social activity usage goals, educational usage goals, and mindfulness usage goals. An activity and context tracking system includes computer instructions operable on the computing system to obtain the user's location, obtain the time of day, obtain motion information from the motion detector, obtain location information from the global positioning receiver, obtain app usage information, obtain operating mode changes for the mobile device. A recommendation engine includes computer instructions operable on a computing system and uses the parameters respecting the goals, as specified using the goal-setting user interface, and information from the activity and context tracking system, and analyzes the acquired information to generate and send messages identifying opportunities for the user to change their behavior to better align the use of the smart phone with the usage goals.

### PRIORITY APPLICATION

This application is a continuation of and claims priority to U.S. patent application Ser. No. 16/520,636, filed on Jul. 24, 2019, the disclosure of which is incorporated by reference herein in its entirety.

### TECHNICAL FIELD

The present disclosure relates generally to the field of smart phones, and more particularly to optimization of smart phone usage.

### BACKGROUND

Recent studies indicate that “screen time” now occupies 90% of discretionary time, with much of that time spent on smart phones. This large allocation of discretionary time to our phones results in many cases of time being diverted away from other, more important, goals. These goals might include something as simple as calling one's parents to check in, studying in pursuit of educational advancement, volunteering time at a favorite charity, or simply getting more sleep.

Spending too much time on apps is not helped by companies that make more money the longer a user stays on their platforms. These companies design their apps and web sites to keep users on their platforms for as long as possible. While ultimately, it is up to the user to choose whether or not they spend time on any given platform, often times users are simply unaware of the amount of time they are spending on any particular platform and the life-tradeoffs they are making by missing out on more highly valued, activities. With so much discretionary time being used on our phones or other computing devices, it is easy to see that more productive endeavors, like studying, exercise, or face-to-face socializing, might get less attention than they merit.

### SUMMARY

According to one example embodiment, there is described a smart phone usage monitoring and management system including a data collection process operating on a smart phone client application (“app”) to collect data related to the usage of a smart phone. This usage data includes, in one example embodiment, data concerning the operational modes of the smart phone, data from or about apps executing on the smart phone, data from or derived from devices operating on the smart phone, and other data. Devices include, in one example embodiment, a GPS receiver or an accelerometer, used to produce GPS coordinates or detect motion of the smart phone. According to one embodiment, the collected data is streamed to a cloud-based server that executes one or more processes to store and transform the usage data into a usage profile for the smart phone, and notifications that can be returned to the smart phone. In one example embodiment, a usage notification causes a change in an operational mode or capability of the smart phone, or a message to be displayed to a user of the smart phone. In another embodiment, processes on the server generate a summary of the smart phone usage data. According to another example embodiment, the smart phone usage data is applied to a machine learning system to transform this data into information useful to provide notifications to a user of the smart phone. According to another example embodiment, the smart phone app displays a usage profile that constitutes a percentage of success against usage goals established by the user, and progress toward usage goals configured by the user. According to another example embodiment, usage goals are associated with a user's goals to perform certain beneficial activities, and a profile is displayed showing how usage of the smart phone corresponds to those activities.

### BRIEF DESCRIPTION OF THE DRAWINGS

FIGS. 1A-1C illustrate the architecture of a smart phone usage monitoring and management system according to an example embodiment.

FIG. 2 illustrates sources of usage data on a smart phone according to an example embodiment.

FIG. 3 illustrates cloud functions according to an example embodiment.

FIG. 4 illustrates usage and user goals according to an example embodiment.

FIG. 5 illustrates a notification function according to an example embodiment.

FIG. 6 illustrates a table of notification rules according to an example embodiment.

FIG. 7 illustrates a master notification controller according to an example embodiment.

FIG. 8 illustrates a notification manager according to an example embodiment.

FIGS. 9A to 9O illustrate a user interface according to an example embodiment.

FIG. 10 illustrates a group management module according to an example embodiment.

FIG. 11 illustrates an example computer system according to an example embodiment.

### DETAILED DESCRIPTION

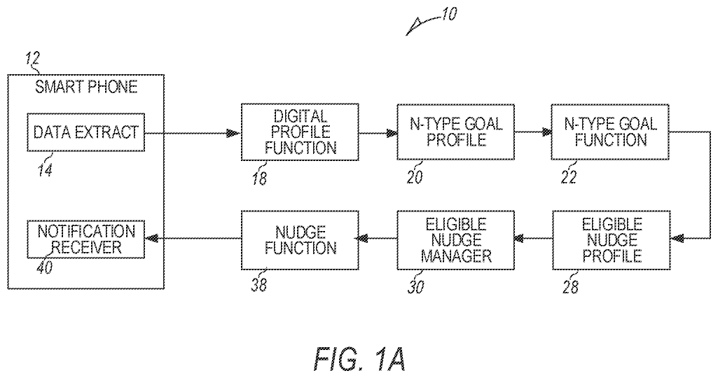

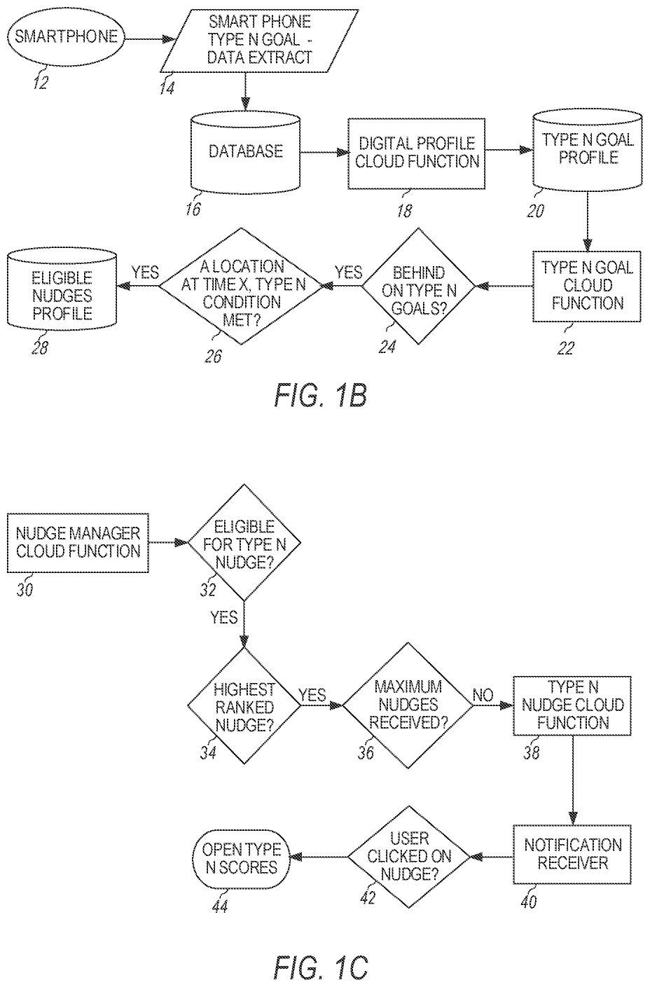

According to one example embodiment, as illustrated in diagrammatic form in FIG. 1A, according to one example embodiment a system 10 provides a scalable architecture for monitoring usage for different types N of usage of the smart phone 12, tracking that usage in an example embodiment, and sending messages regarding that usage to the smart phone, wherein the messages are used to display information to a user and/or alter the operational state of the smart phone. According to one example embodiment, data extracts 14 from the smart phone 12 are used by a digital profile function 18 to create an N-type goal profile 20 for each of a plurality of different N-type usages of the smart phone. An N-type goal function 22 obtains data from a respective N-type goal profile 20 for an N-type usage goal and determines if the usage of the smart phone 12 is ahead of, behind, or meeting the usage goal specified for an N-type usage goal. In one example embodiment, this determination is made using the location of the smart phone 12, and/or the time of day. If the smart phone is behind its usage goal of N-type, for a given period of time, an eligible nudges profile 28 is updated to include a message to send to the smart phone 12 in relation to the usage goal of N-type, in order to increase the usage of the smart phone relative to the N-type usage goal. Eligible nudge profile 28 thus can specify one or more messages that can be delivered to the smart phone 12 in order to meet usage goals for one or more different N-type usage goals for the smart phone.

In one example embodiment, the message sent to the smart phone 12 is used to control an operational capability of the smart phone. In example embodiments, capabilities to control with a message include enabling or disabling the operation of an app installed on the smart phone. In other example embodiments, the messages sent to the smart phone are intended to be delivered to a user of the smart phone. Such messages, in one embodiment, are intended to influence use of the smart phone, for example by encouraging or “nudging” the user toward certain uses or non-uses of the smart phone.

According to one example embodiment, a nudge manager function 30 determines if the smart phone 12 is eligible to receive an N-type nudge specified by eligible nudge profile 28. If one of the N-type nudge messages in the eligible nudge profile 28 is ranked highest among eligible nudge messages, and if the maximum number of N-type messages have not yet been received during a specified period of time, the nudge manager function 30 directs that the N-type nudge message be sent to the smart phone 12 by an N-type nudge function 38. A notification receiver 40 deployed on smart phone 12 receives the respective N-type nudge message and presents the message on a user interface 215 of the smart phone 12. The user of the smart phone 12 can view the message, and also, to view a corresponding score representing the degree to which the N-type usage goal has been achieved for the smart phone 12 during a particular period, such as a given day. In one example embodiment, a day begins at 12:00 AM and lasts to 12:00 PM, but a day may begin and end on other cycles of more or less than 24 hours in length, for example a day may be from 5:00 AM to 12:00 PM.

The functions described above are, in one example embodiment, constituted by one or more software components including computer program code, wherein the software components cooperate to provide the described functionality. According to one example embodiment, the software components are located remotely from one another, such as one component located on the smart phone while another is located on one or more remote servers on the internet, or as alternately referred to, in the cloud.

Referring now to FIG. 1B, there is illustrated another example embodiment of a usage monitoring and management system for a smart phone 12. A data extract 14 for an N-type usage goal is obtained from a smart phone 12. The data extract 14 is stored in a database 16, which in one example embodiment is a cloud-hosted, NoSQL, Firestore® database. Digital profile cloud function 18, deployed in the cloud in one example embodiment, obtains data from the database 16, and maintains an N-type goal profile 20 for an N-type usage goal. N-type goal cloud function 22, deployed in the cloud in one example embodiment, obtains data from the N-type goal profile 20, for an N-type usage goal, and determines 24 if the usage of the smart phone 12 is ahead of, behind, or meeting the usage goal specified for an N-type usage. According to one example embodiment, the location of the smart phone 12, and/or the time of day, is determined 26, and is used to make this determination. The eligible nudges profile 28 is updated and stored in a database, for example database 16.

Referring now to FIGS. 1B and 1C, the nudge manager function 30, deployed in the cloud in one example embodiment, determines 32 if a smart phone 12 is eligible to receive an N-type nudge specified by the eligible nudge profile 28 for the respective smart phone 12. If the specified N-type nudge message is ranked highest 34 among eligible nudge messages, and if the maximum number of N-type messages have not yet been received 36 during a specified period of time, the N-type nudge message is sent to the smart phone 12 by N-type nudge function 38, deployed in the cloud in one example embodiment. The notification receiver 40 deployed on smart phone 12 receives the respective message from the N-type nudge function 38, and presents the message on a user interface 215 of the smart phone 12, to allow a user of the smart phone 12 to view it, for example by clicking on a notification that the message has been received on the smart phone 12. According to one example embodiment, the smart phone displays 44 the message and, optionally, a score representing the degree to which the N-type usage goal has been achieved for the smart phone 12.

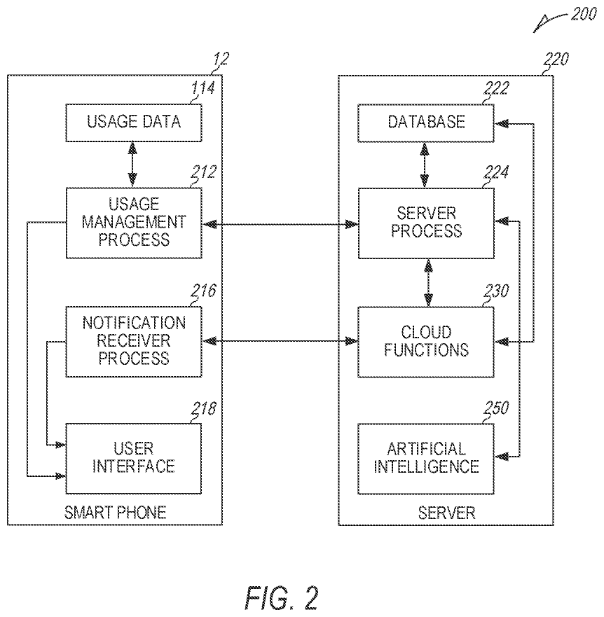

Referring now to FIG. 2, there is described a high-level overview of an example system architecture 200 for a smart phone usage monitoring and management system, according to an example embodiment. A smart phone 12, or more generally a handheld mobile computing device, acts as a client in a client-server architecture, and executes a usage management process 212, controlled by a smart phone app installed on smart phone 12. Usage management process 212 fetches or receives usage data 214 from smart phone 12.

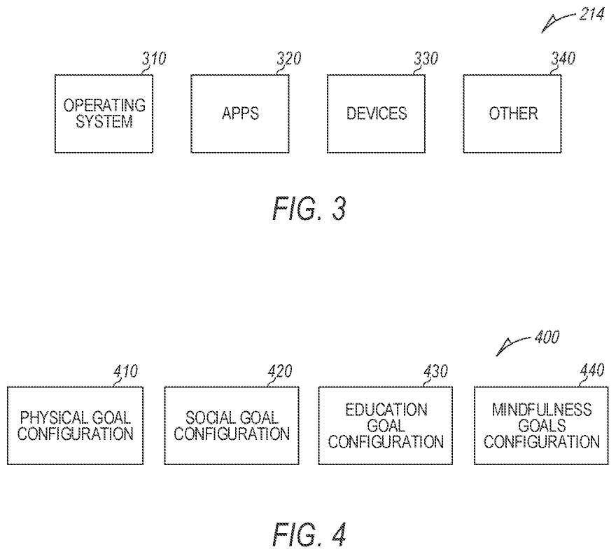

As illustrated in FIG. 3, usage data 214 can include, in one example embodiment, data 310 from the operating system including the operational modes of the smart phone, data 320 from or about apps executing on the smart phone, data 330 from or derived from devices operating on the smart phone, and other data 340. Devices include, in one example embodiment, a GPS receiver and an accelerometer, used to detect the location or physical movement of the smart phone. In another embodiment, usage data 214 includes the time of use and duration of use of apps on the smart phone 12. Usage management process 212 streams usage data 214 to a server 220.

According to another embodiment, the usage management process 212 monitors the phone's operational mode to detect when the phone transitions from a doze/sleep mode into an awake mode and vice versa. According to one embodiment, the transition is captured and logged in the database 222 of server 220. According to another example embodiment, app usage data 214 concerning what apps were used and when and where were they used, is obtained by usage management process 212. According to one embodiment, process 212 is configured to receive usage data 214 for a specific list of apps on the smart phone 12. According to one embodiment, the list is maintained in a database 222 on server 220. The characteristics and/or attributes of each app are stored and used to assist in gathering and interpreting data from each respective app. According to another example embodiment, apps are categorized by type of activities they represent, and these categories are then used in part to summarize smart phone usage, and by proxy, the smart phone user's activities.

Usage data 214 is used, in one example embodiment, to determine if the usage of any given app, or overall usage, is consistent with user's preferences for phone usage. Accordingly, in example embodiments, the smart phone usage monitoring and management system tracks “digital decisions” of a user and identifies areas where the user is being consistent with their goals and areas where they aren't. For example, if the user spends time on a reading app, and the user has a learning preference for his or her educational usage goals, then such usage would be count toward that goal. On the other hand, if the usage of the smart phone was time on a social media app, and not enough time on an app in the education category/subcategory of usage in their preferences, the user may receive a notification that his or her usage is inconsistent with their educational usage goals.

A process 224 on server 220 receives the stream of usage data 214 from usage management process 212 and stores it in a database 222. According to one example embodiment, the smart phone 12 and server 220 track, collect and/or store context data that is used in analysis of smart phone usage. Such context data includes, in one example embodiment, data indicative of the location of the smart phone 12 and time of day. According to one example embodiment, this context data, along with other usage data 214 such as app usage, is used as described herein below, to determine a notification to issue to a user. For example, a notification, in one example embodiment, is based on the location of the smart phone 12, and presumably also the user of the phone, the time of day, and the app being used by the user. For example, if the smart phone 12 is being used to view screens of the Facebook® app at 2 A.M., a notification suggesting it would be wise to go to bed/sleep, would be better compared to a notification suggesting to call a friend in a list of social contacts the user wants to keep up with. According to this example embodiment, the absence of phone usage in the nighttime is used as a proxy for a phone user's sleep cycle. In another example embodiment, usage management process 212 is configured to obtain data from a pedometer app that determines how many steps or how far a user has walked to assess a user's level of physical activity.

Server process 224 provides data from the database 222 to one or more of a plurality of specialized cloud functions 230 to handle tasks to process the usage data 214. In addition, server process 224 can export some or all of the usage data 214, for example stored in the database 222, to an artificial intelligence/machine learning system 250, described in more detail below, that can be deployed on server 220 or one or more other servers. According to one example embodiment, cloud functions include various functions to perform operations on the usage data 214. These functions include, in one example embodiment, a summary function to summarize the usage data 214 and assemble a usage profile, indicating a usage of the smart phone and by proxy the activities of the smart phone's user. The usage profile is, in one example embodiment, usage of the smart phone during any given period or periods of time. According to another example embodiment, a usage profile is based on the last seven days of usage data 214 and based on data for the current day.

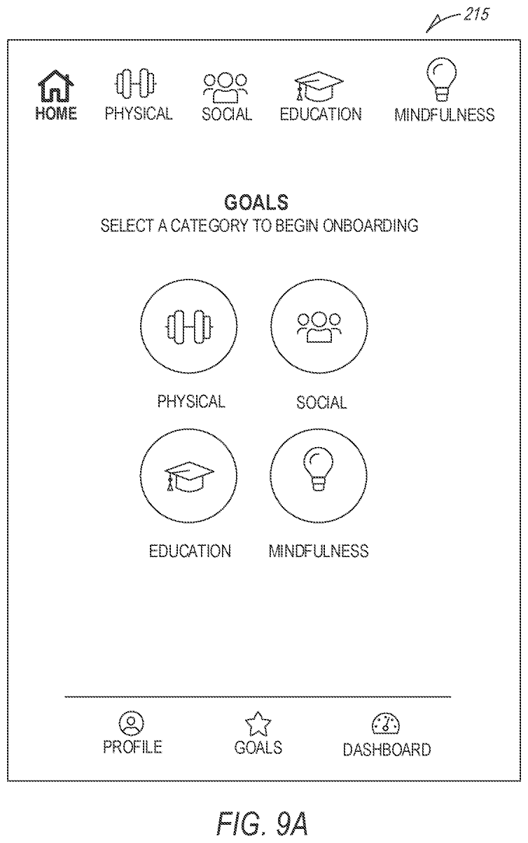

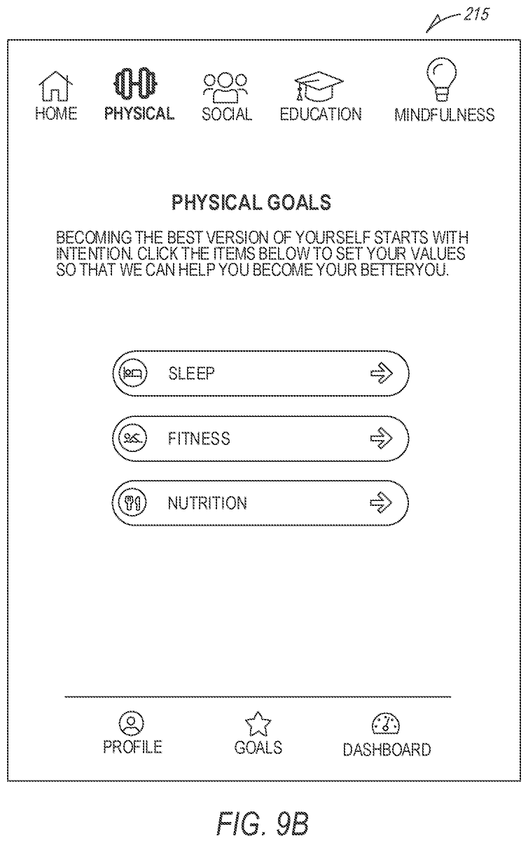

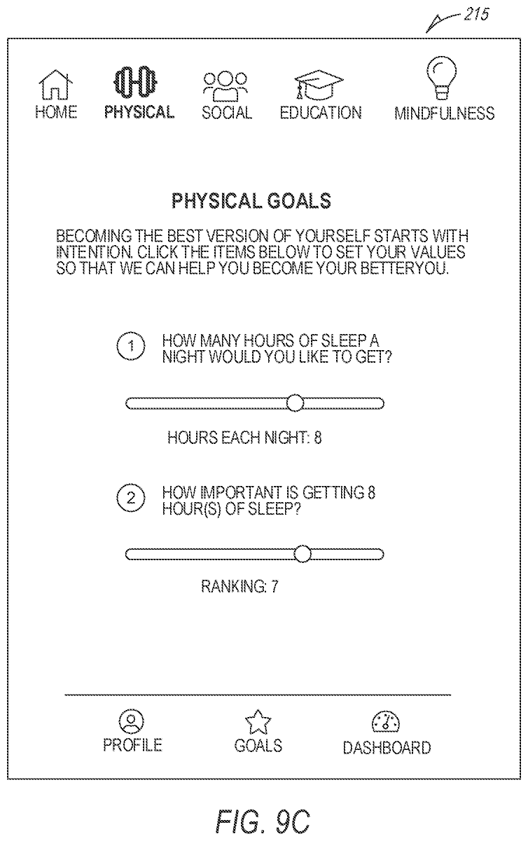

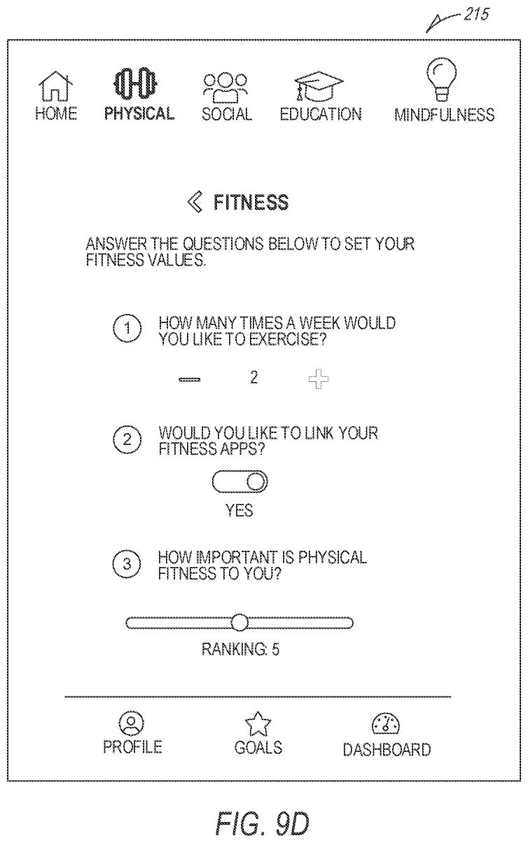

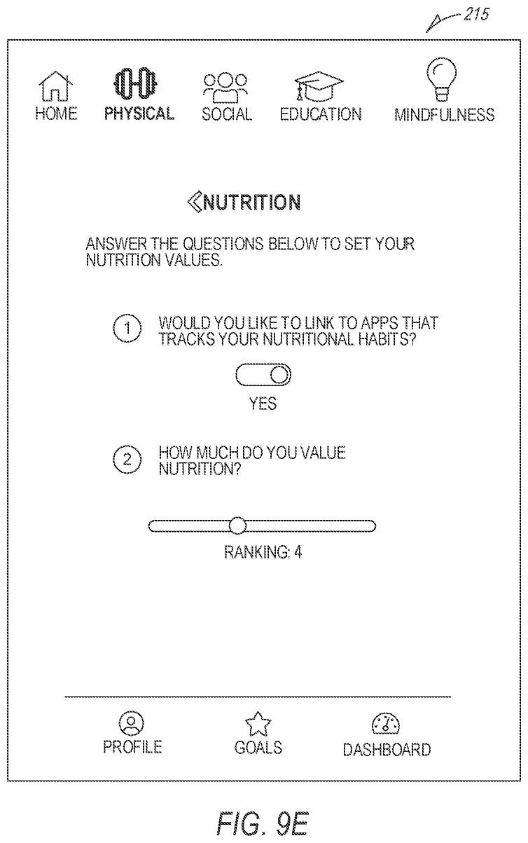

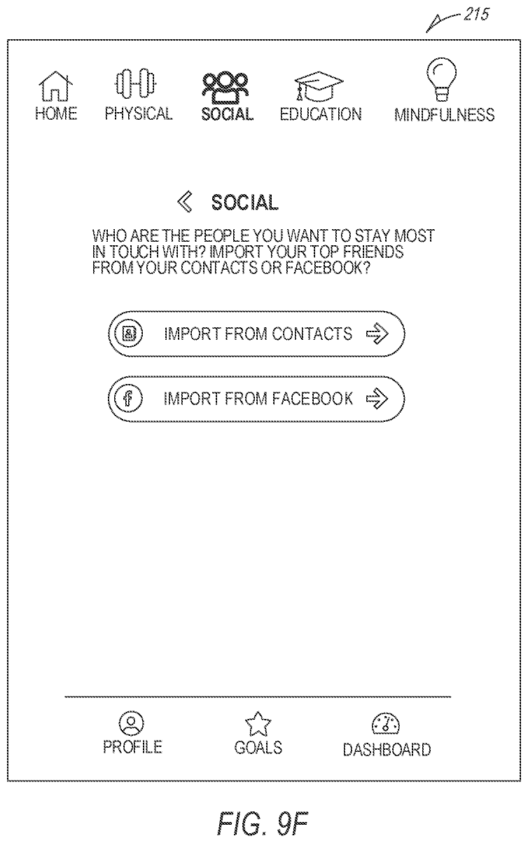

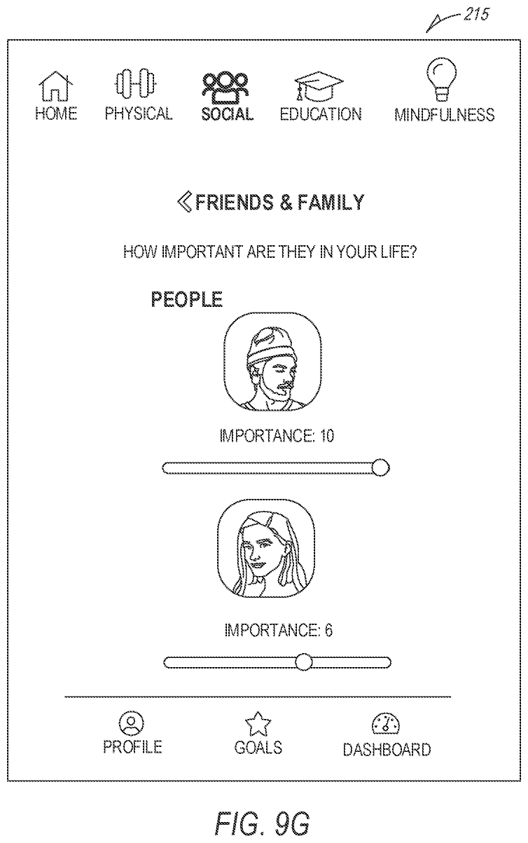

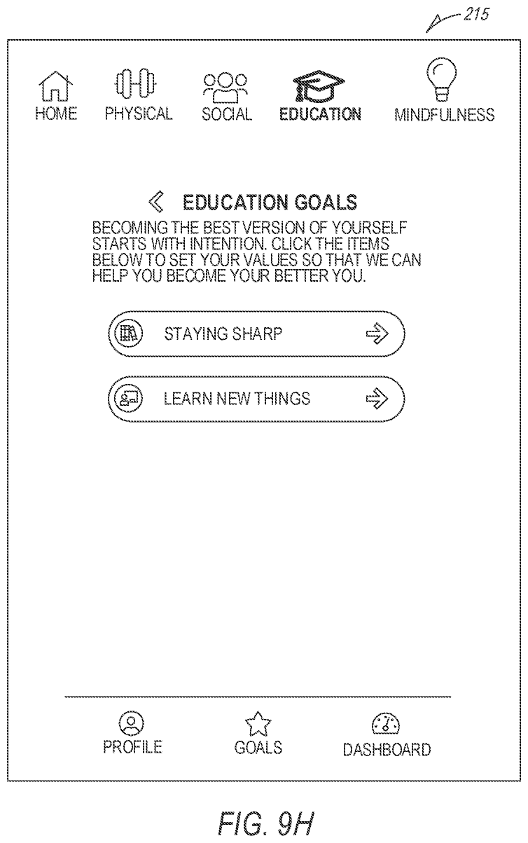

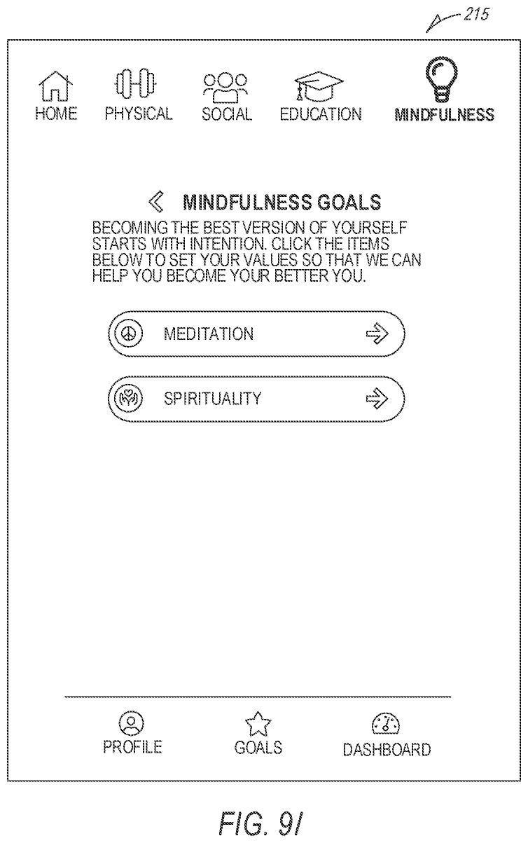

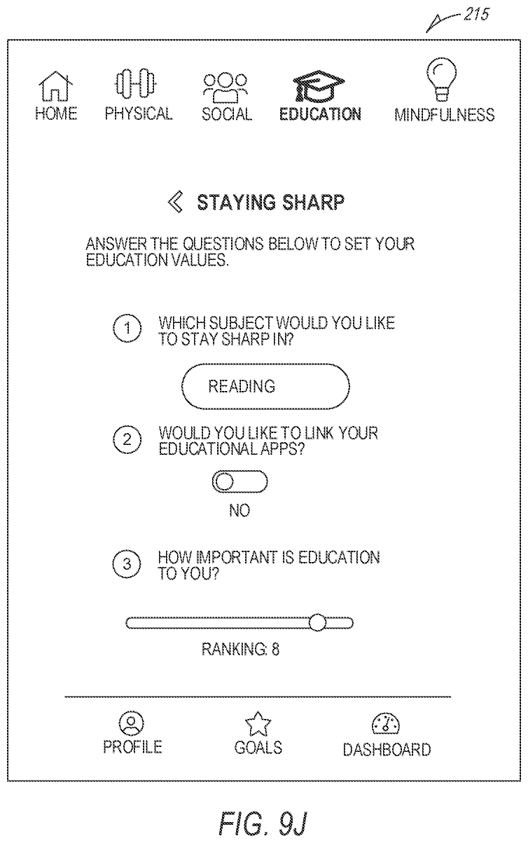

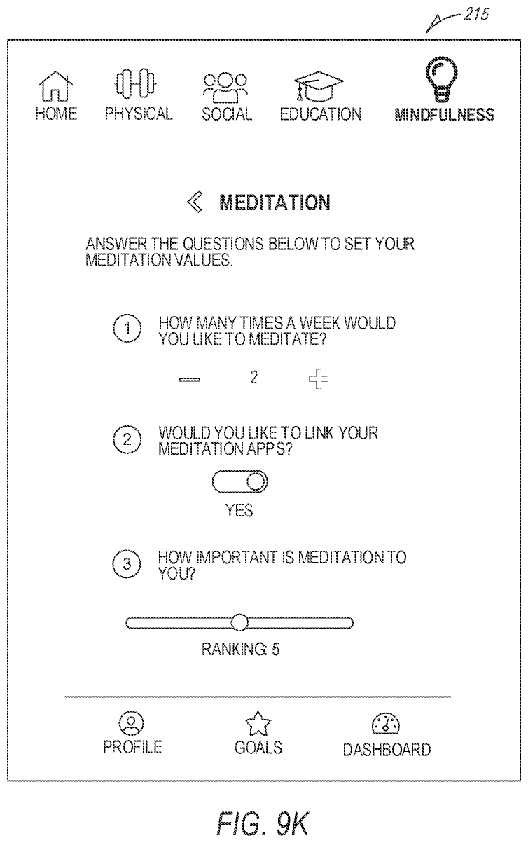

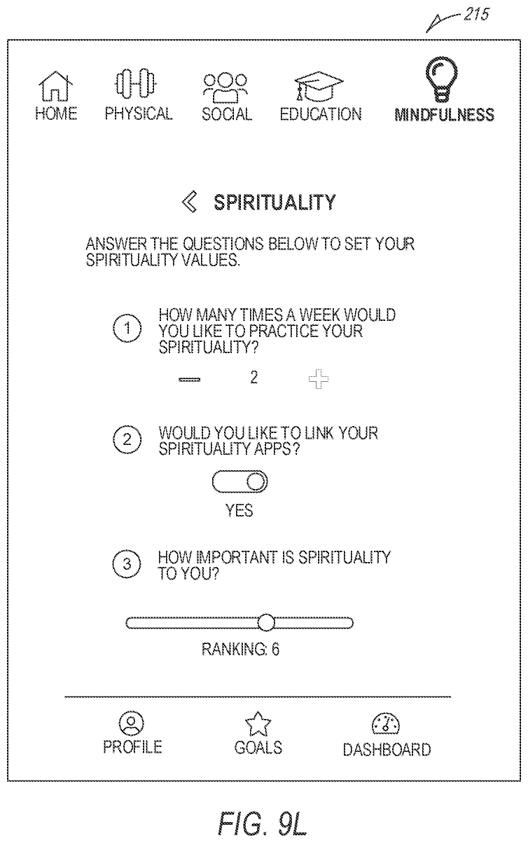

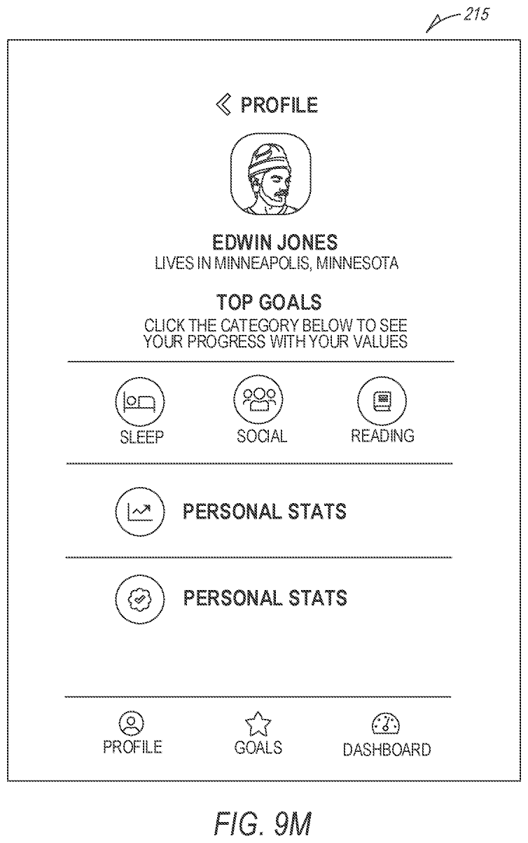

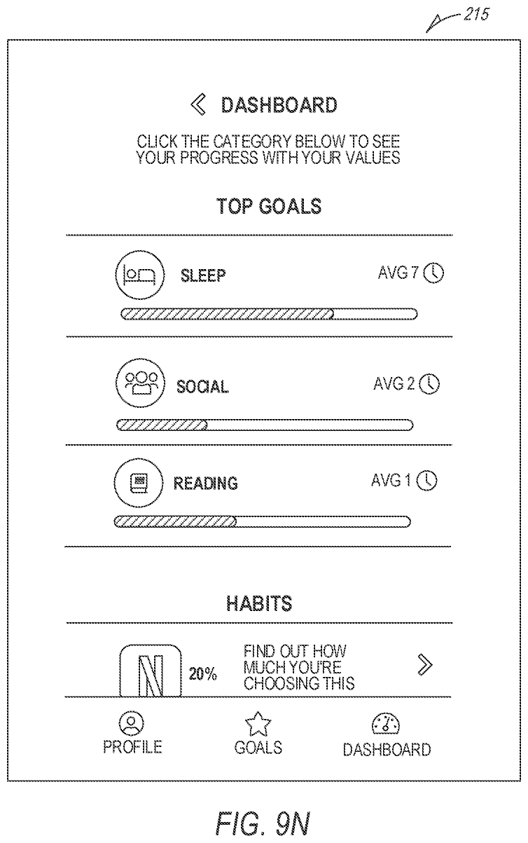

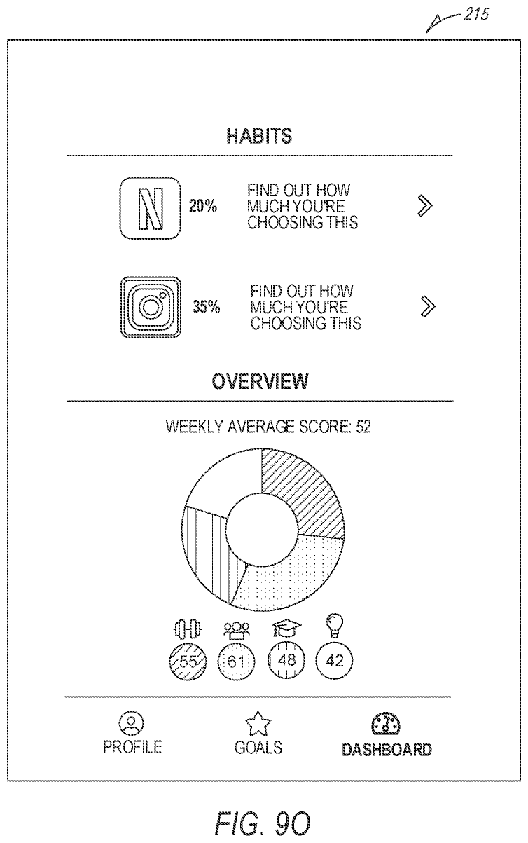

Cloud functions 230 also, in one example embodiment, take the form of notification functions, that determine a notification (also referred to as “nudges” herein) to send to a user based on user configuration data stored in database 222 and configured through the user interface 215 (described in detail below with reference to FIGS. 9A-9O). For instance, a notification function may remind a user to take an action or refrain from taking an action. According to one example embodiment, notifications are pushed as text to smart phone 12 from server 220. As illustrated in FIG. 2, the smart phone 12 includes a notification receiver process 216 that receives a notification from a notification channel on the smart phone. The receiver process 216 is, in one example embodiment, a process that receives the notification, and in response thereto, display messages and/or images and icons to a user of the smart phone 12 on user interface 215.

Referring now to FIG. 4, there is illustrated a set of configuration options 400 that can be added and updated through the user interface 215 (shown in FIGS. 9A to 9O) to allow a user to configure the system to generate notifications according to the user's preferences. According to one example embodiment, the configuration options 400 include setting preferences for usage goals relating to physical activity 410, usage goals relating to social activities 420, usage goals relating to education 430 and usage goals relating to mindfulness 440. In one example embodiment, these preferences are stored on server 220 in database 222 and are set using the user interface 215 described further below.

According to one example embodiment, for physical activity usage goals 410, users can configure preferences for sleep and exercise. In one example embodiment, a user sets how many hours of sleep they would like to get each night and how important sleep is to them on a 1-10 scale. According to another example embodiment, a user sets an exercise goal for how many times a week they would like to get exercise, and how important exercise is to them on a 1-10 scale. According to other example embodiments, other physical activity usage goals 410 are configured.

According to another example embodiment, for social activity usage goals 420, users can configure preferences for keeping in touch and events to attend. In one example embodiment, a user specifies up to five people that they would like to stay in touch with throughout the month. According to another example embodiment, a user specifies how many events they would like to attend each month, as for example might be learned of from a service like Google® Places®. According to other example embodiments, other social activity usage goals 420 are configured.

According to another example embodiment, for educational usage goals 430, users can configure preferences for topics to learn and/or skills to acquire. In one example embodiment, a user specifies one or more topics to learn, and how important they are to the user, and/or skills to acquire, and how important they are to the user. For example, a user may specify the goal to learn a new language and give it a high importance rating. According to another example embodiment, a user may specify a goal of spending time in the library or at school. According to other example embodiments, other educational usage goals 430 are configured.

According to another example embodiment, for mindfulness usage goals 440, users can configure preferences for meditation and spirituality. In one example embodiment, a user sets how much time a day or week they would like to spend in reflection and meditation. According to another example embodiment, a user sets how much time a day or week they would like to spend on spirituality, and a location for this activity, such a place of worship. According to other example embodiments, other mindfulness usage goals 440 are configured.

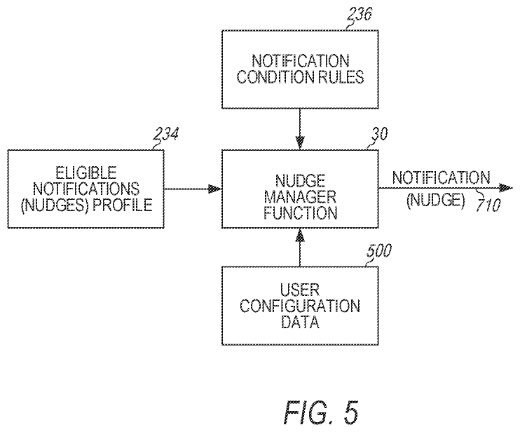

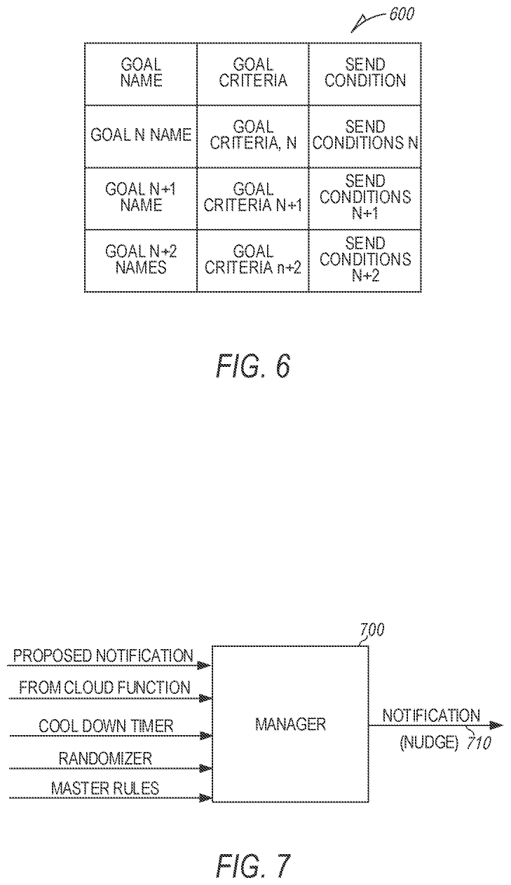

Referring now to FIG. 5, there are illustrated the nudge manager function 30 to determine a notification to send to a user based on user configuration data 500 stored in server 220. According to one example embodiment, user configuration is accomplished through the user interface 215 (see FIGS. 9A to 9O), described in more detail below. According to an example embodiment, potential notifications are identified and are aggregated in a notification profile data structure as eligible notifications 134. Using one or more of notification condition rules 136 the nudge manager function 30 determines if and when an eligible notification will be sent. Examples of a data structure for usage goals are shown in table 600 of FIG. 6. This structure includes a usage goal name N, criteria N for the usage goal, and conditions N for sending a notification to the smart phone 12.

According to one embodiment, illustrated in FIG. 7, notification manager 700 determines if a proposed notification is in turn transmitted to the user's smart phone 12 as a notification. For example, according to a first rule, the foreground time on the smart phone is monitored, and generates a notification condition if the user is working on the phone between 1 AM and 5 AM. If the conditions for the transmission of a notification to the user are met, a notification is sent to the user's smart phone app. According to another example rule, where the user has a fitness goal to attain a desired level of walking, a notification condition is detected when the user has not achieved a desired number of steps by a certain point or points in the day. A determination of whether or not to send a notification to the user to initiate more walking may depend, in one example embodiment, on the duration or timing of a user's daily exercise pattern, or the location of the user at a particular point in time, for example if the user is near a location they have walked in the past, and/or how much of the user's daily goal has been achieved at that particular time. According to another example embodiment screen time, user location and time of day is monitored and a proposed notification is generated and conveyed to the notification manager 700 (discussed in detail with reference to FIG. 7), which determines if the circumstances are present to send another notification to the user, such as time of day and/or location of the user. For example, if the user of the smart phone doesn't normally call his mother when at work, she is not encouraged to call her when at work. Alternatively, if it is too late in the day, the user is not encouraged to call her mother.

According to one example embodiment, illustrated in FIG. 7, a notification manager 700 that includes a timer that starts a cool down period after a notification is sent, such that no further notifications (nudges) 710 are sent until the cool down period is complete. According to an example embodiment, this assures that users are not overwhelmed with notifications (nudges) 710. Accordingly, before any given notification function sends a notification (e.g., a nudge) 710, it checks to see if the system is inside a cool down period and suppress the notification until the cool down mode period times out or otherwise ends. According to another example embodiment, notifications 710 are spread out over time and random, but within a defined window of time. According to another example embodiment, notifications 710 may be suppressed or blocked when a user is at work or suppressed or blocked when the user is over a certain percentage of progress toward a goal, for example 85% of goal. According to another example embodiment, notification manager 700 provides that users do not receive notifications at the wrong time or place.

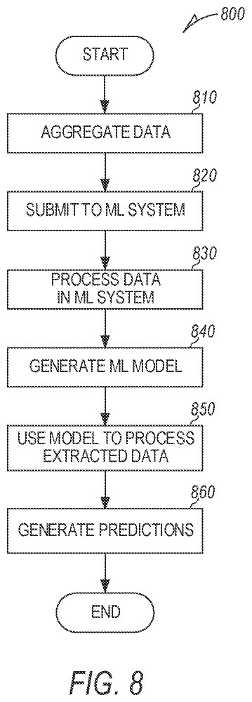

According to one example embodiment, an artificial intelligence process, illustrated in FIG. 8, uses a machine learning process 800 to analyze usage data to perform a number of functions including setting up a user's profile dynamically such as determining where the user lives or works automatically. In addition, machine learning determines, based on data logged in database 222, how a user is likely to spend his or her day using their smart phone 12, predict usages that are inconsistent with usage goals, and provide notifications 710 to the user to intervene prior to the user diverging from a goal. According to the machine learning process 800, data extracted from a smart phone 12 is aggregated 810 in the database 222 and submitted 820 to a machine learning system (e.g., 250 in FIG. 2) that processes 830 the data and creates a machine learning model 840 with one or more endpoints to receive data extracted from a smart phone 12 and produce desired outputs 850 such as a prediction of a user's future usage past on past usage. The machine learning model 840 thus allows usage data to be used to predict and anticipate smart phone 12 usage before it happens and generate predictions 860 that prompt notifications (nudges) 710, to be sent to the user.

Referring now to FIGS. 9A-9O, there is illustrated a touch screen user interface 215 screen of a smart phone app installed and operable on the smart phone 12, according to an example embodiment. Referring to FIG. 9A, there is illustrated an example embodiment of a touch screen user interface allowing a user to select a category of goals to begin onboarding offering physical, social, education and mindfulness goals for usage of the smart phone, as options.

If the user chooses the physical goals option, the user interface 215 offers sleep, fitness or nutrition, as illustrated in FIG. 9B, and FIG. 9C shows the options presented if the user selects a sleep goal, where the user can specify the number of hours they seek to sleep and the importance of getting the number of hours of sleep they specify, on a scale of 1-10. FIG. 9D illustrates the options if the user selects fitness goals to specify, including how many times a week they seek to exercise, if they want the smart phone app to be linked to fitness apps on the smart phone 12, and asked to rate the importance of the exercise goal on a scale of 1-10.

If the user selects nutrition as a physical goal, the user interface 215 of FIG. 9E asks the user if they want to link the smart phone app to apps that track nutrition, and how much they value nutrition on a scale of 1-10. If the user selects social goals, the user interface 215 of FIG. 9F first asks the user to identify the most important people they wish to stay in touch with and allows the user to import people from their contacts address book or from Facebook. The user interface 215 then asks the user to rate the importance of people identified by the user, such as friends and family, as illustrated in FIG. 9G.

If the user chooses educational goals, they can choose between the options of staying sharp or learning new things, as illustrated in FIG. 9H. If the user chooses mindfulness goals, the user interface 215 offers medication and spirituality as options, as illustrated in FIG. 9I. If the user selects staying sharp in the user interface 215 screen of FIG. 9H, the user interface 215 of FIG. 9J asks the user which subject that they would like to stay sharp in, such as reading, and whether the user wishes to link the smart phone app to educational apps on the smart phone, such as an electronic book app. Also, the user is asked how important staying sharp is to the user on a scale of 1-10.

If the user selects meditation as a goal, they are presented the user interface 215 of FIG. 9K, and asked how many times a week they would like to meditate, whether they would like to link the app to any meditation apps on the smart phone, and how important meditation is to the user on a scale of 1-10. If the user selects spirituality as a goal, the user is presented with the user interface 215 illustrated in FIG. 9L, and asked how many times a week they would like to practice spirituality, whether they would like to link the app to any spirituality apps on the smart phone, and how important spirituality is to the user on a scale of 1-10.

As illustrated in FIG. 9M, a user interface 215 profile screen presents identification information for the user, shows each of the top goals selected by the user, and allows the user to select a displayed goal to see their progress with their values as indicated in setting up the goals as described above. If the user selects the dashboard option displayed on a user interface 215 screen, as shown in FIG. 9N, the user interface 215 displays stats on the user's progress toward their top goals. Also, the user interface 215 shows habits of the user, such as the time the smart phone 12 has been used for certain purposes, such as, for example, watching Netflix®. As shown in FIG. 9O, the percentage of time on certain apps can be shown as habits, and a weekly average score of attainment of the user's goals is displayed.

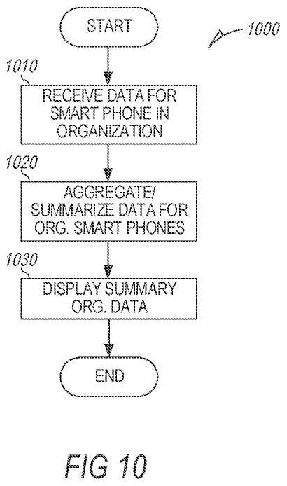

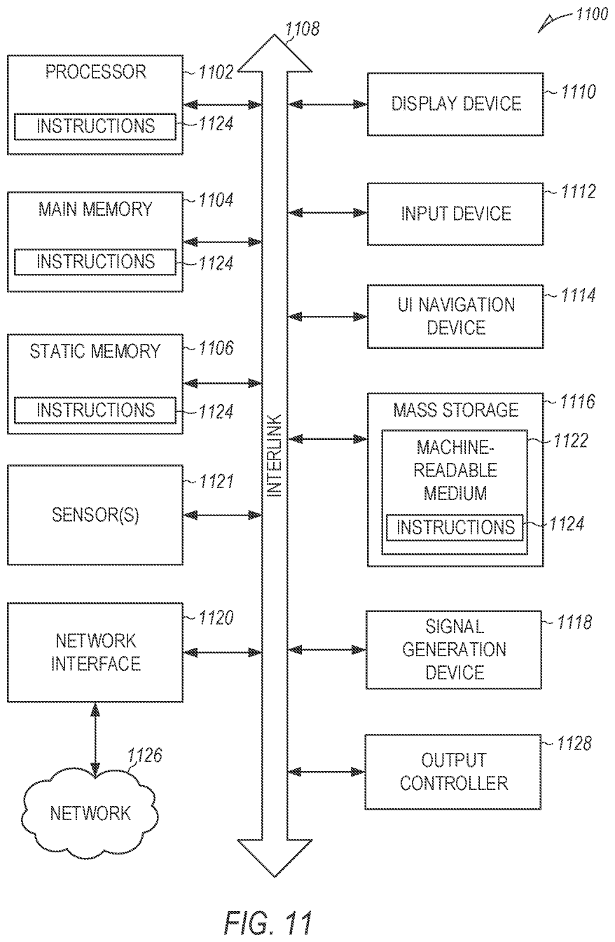

Referring to FIG. 10, there is illustrated an organization configuration process 1000 that allows an organization to establish configuration options 400 for members of its organization. According to an embodiment, data from a plurality of smart phones associated with an organization, such as smart phones issued by a corporation, or used by members of an organization such as a corporation, educational group, or other entity, provide data that is received for processing 1010. The data is received, aggregated and summarized 1020, and the summary is displayed 1030. According to another example embodiment, an organization is provided a summary profile to display the group's percentage of progress toward weekly goals. These goals, like those for individuals, are broken down by category and then summarized.

Example Computer System

FIG. 11 illustrates an example computing system 1100 used in a room fitness instrument according to an example embodiment. The data processing capabilities described herein smart phone 12 and server 220 may be implemented in one or a combination of hardware, firmware, and software. Embodiments may also be implemented as instructions 1124 stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an app) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configure each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

FIG. 11 illustrates a block diagram of an example machine 1100 upon which any one or more of the techniques (e.g., methodologies) discussed herein may perform. For instance, the computing system elements of the smart phone 12 program may be implemented as shown and described with respect to FIG. 11. In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. The machine 1100 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, movable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 1100 may include a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1108. The machine 1100 may further include a display unit 1110, an alphanumeric input device 1112 (e.g., a keyboard), and a user interface (UI) navigation device 1114 (e.g., a mouse). In an example, the display unit 1110, input device 1112 and UI navigation device 1114 may be a touch screen display. The machine 1100 may additionally include a storage device (e.g., drive unit) 1116, a signal generation device 1118 (e.g., a speaker), a network interface device 1120, and one or more sensors 1121, such as a global positioning system (GPS) sensor, compass, accelerometer, or other sensors. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1116 may include a machine readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within static memory 1106, or within the hardware processor 1102 during execution thereof by the machine 1100. In an example, one or any combination of the hardware processor 1102, the main memory 1104, the static memory 1106, or the storage device 1116 may constitute machine readable media.

While the machine readable medium 1122 is illustrated as a single medium, the term “machine readable medium” may include a single medium or multiple media (e.g., a centralized or distributed database or electronic data repository, and/or associated caches and servers) configured to store the one or more instructions 1124.

The term “machine readable medium” may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Non-limiting machine readable medium examples may include solid-state memories, and optical and magnetic media. In an example, machine readable media may exclude transitory propagating signals (e.g., non-transitory machine-readable storage media). Specific examples of non-transitory machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1124 may further be transmitted or received over a communications network 1126 using a transmission medium via the network interface device 1120 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 1102.11 family of standards known as Wi-Fi®, IEEE 1102.16 family of standards known as WiMAX®), IEEE 1102.15.4 family of standards, peer-to-peer (P2P) networks, 3^{rd} Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1100, and includes digital or analog communications signals or other intangible medium to facilitate communication of such software. A computer-readable medium can comprise a non-transient storage medium or a transient medium, such as a transmission medium.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Thus, as described above, according to one example embodiment, there is described herein a system for tracking electronic and physical smart phone activity including but not limited to location data and app usage data 114, streaming that data to a remote server, automatically interpreting and transforming that data on the remote server, and transmitting electronic control data to the smart phone.

According to one example embodiment, system 10 is used to assist users of a smart phone to develop habits and tendencies to the user's goals. According to one example embodiment, described above, a user interface 215 facilitates the configuration of electronic processes to interpret and transform the data according to user preferences. The user interface 215 is further adapted to present information and user-control features that allow for navigation through an array of user interface 215 screens adapted to receive touch entries.

1. (canceled)

2. A user device for monitoring and management of a plurality of usage goals, the user device comprising at least one processor and at least one non-transitory memory including computer-coded instructions thereon, the computer-coded instructions, with the at least one processor, configure the user device to:
display a usage goal-setting user interface of the plurality of usage goals to a user;
receive input from the user that comprises at least one configuration for each usage goal of the plurality of usage goals;
receive a rule indicating at least one notification condition, the at least one notification condition based on at least one of a user device's location, a time of day, or a day of the week;
receive a usage data and a context tracking data of the user device;
determine, using a machine learning process, a prediction of future user behavior based on the usage data and the context tracking;
determine whether the user met each usage goal of the plurality of usage goals based on the usage data, the context tracking data, and the at least one configuration for each usage goal of the plurality of usage goals; and
send a notification based on the rule indicating at least one notification condition, the prediction of future user behavior, and the determination of whether the user met each usage goal of the plurality of usage goals, wherein at least one of the notification includes a suggestion for the user to change their behavior, a suggestion for the user to take an action positive to the plurality of usage goals, or a suggestion for the user to refrain from taking an action negative to the plurality of usage goals.

3. The user device of claim 2, wherein at least one of the context tracking data includes:
an operational mode of the user device;
a location of the user device; or
a physical movement of the user device.

4. The user device of claim 2, wherein at least one of the usage data includes:
an information from an app;
an information about the app;
the usage goal associated with the app;
a user's location when the user is using the app; or
a time of day when the user is using the app.

5. The user device of claim 2, wherein at least one of the plurality of usage goals includes:
a physical activity goal;
a social activity goal;
an education goal; or
a mindfulness goal.

6. The user device of claim 5, wherein the at least one configuration of the physical activity goal includes:
a number of hours of sleep;
a number of hours of exercise;
a number within a 1-10 sleep importance scale; or
a number within a 1-10 exercise importance scale.

7. The user device of claim 5, wherein the at least one configuration of the social activity goal includes:
a list of people for keeping in touch; or
a number of events per month.

8. The user device of claim 5, wherein the at least one configuration of the education goal includes:
a topic to learn;
a skill to learn;
a number within a 1-10 topic importance scale; or
a number within a 1-10 skill importance scale.

9. The user device of claim 5, wherein the at least one configuration of the mindfulness goal includes:
an amount of time for reflection and meditation;
an amount of time on spirituality; or
a worship place.

10. A computer-implemented method for monitoring and management of a plurality of usage goals, the computer-implemented method including:
displaying a usage goal-setting user interface of the plurality of usage goals to a user;
receiving input from the user that comprises at least one configuration for each usage goal of the plurality of usage goals;
receiving a rule indicating at least one notification condition, the at least one notification condition based on at least one of a user device's location, a time of day, or a day of the week;
receiving a usage data and a context tracking data of a user device;
determining, using a machine learning process, a prediction of future user behavior based on the usage data and the context tracking;
determining whether the user met each usage goal of the plurality usage goals based on the usage data, the context tracking data, and the at least one configuration for each usage goal of the plurality usage goals; and
sending a notification based on the rule indicating a notification condition, the prediction of future user behavior, and the determination of whether the user met each usage goal of the plurality of usage goals, wherein at least one of the notification includes a suggestion for the user to change their behavior, a suggestion for the user to take an action positive to the plurality of usage goals, or a suggestion for the user to refrain from taking an action negative to the plurality of usage goals.

11. The computer-implemented method of claim 10, wherein at least one of the context tracking data includes:
an operational mode of the user device;
a location of the user device; or
a physical movement of the user device.

12. The computer-implemented method of claim 10, wherein at least one of the usage data includes:
an information from an app;
an information about the app;
the usage goal associated with the app;
a user's location when the user is using the app; or
a time of day when the user is using the app.

13. The computer-implemented method of claim 10, wherein at least one of the plurality of usage goals includes:
a physical activity goal;
a social activity goal;
an education goal; or
a mindfulness goal.

14. The computer-implemented method of claim 13, wherein the at least one configuration of the physical activity goal includes:
a number of hours of sleep;
a number of hours of exercise;
a number within a 1-10 sleep importance scale; or
a number within a 1-10 exercise importance scale.

15. The computer-implemented of claim 13, wherein the at least one configuration of the social activity goal includes:
a list of people for keeping in touch; or
a number of events per month.

16. The computer-implemented of claim 13, wherein the at least one configuration of the education goal includes:
a topic to learn;
a skill to learn;
a number within a 1-10 topic importance scale; or
a number within a 1-10 skill importance scale.

17. The computer-implemented of claim 13, wherein the at least one configuration of the mindfulness goal includes:
an amount of time for reflection and meditation;
an amount of time on spirituality; or
a worship place.
